(19) United States
(12) Patent Application Publication
(10) Pub. No.: US 2014/0224745 A1
(43) Pub. Date: Aug. 14, 2014

(54) FLOTATION APPARATUS

(71) Applicant: David Douglas Lloyd, Wotton-Under-Edge Gloucestershire (GB)

(72) Inventor: David Douglas Lloyd, Wotton-Under-Edge Gloucestershire (GB)

(73) Assignee: ENHYDRA LTD, Wotton-Under-Edge,Gloucestershire (GB)

(21) Appl. No.: 14/342,244

(22) PCT Filed: Aug. 21, 2012
(86) PCT No.: PCT/GB2012/000669

§ 371 Date: Apr. 29, 2014

(30) Foreign Application Priority Data
Sep. 3, 2011 (GB) 111528909

(51) Int. Cl. C02F 1/24

(52) U.S. Cl. CPC C02F 1/24
USPC 210/703; 210/521; 210/512.1; 210/519; 210/800; 210/712

(57) ABSTRACT

Apparatus 10 for separating a mixture of oil and water. The apparatus 10 comprises a cylindrical vessel 12, with a cylindrical divider 18 separating the vessel 12 into a central zone 24 and outer annular zone 22. An upper part of the divider 18 provides a weir to enable fluid in the central zone 24 to pass into the outer zone 22. A tangential inlet extends into the central zone 24 at a lower part of the vessel 12, with an outlet 36 at the upper end of the vessel 12 for oil and/or gas, and a water outlet 42 on the side of the vessel 12 a small distance above the bottom of the outer zone 22.

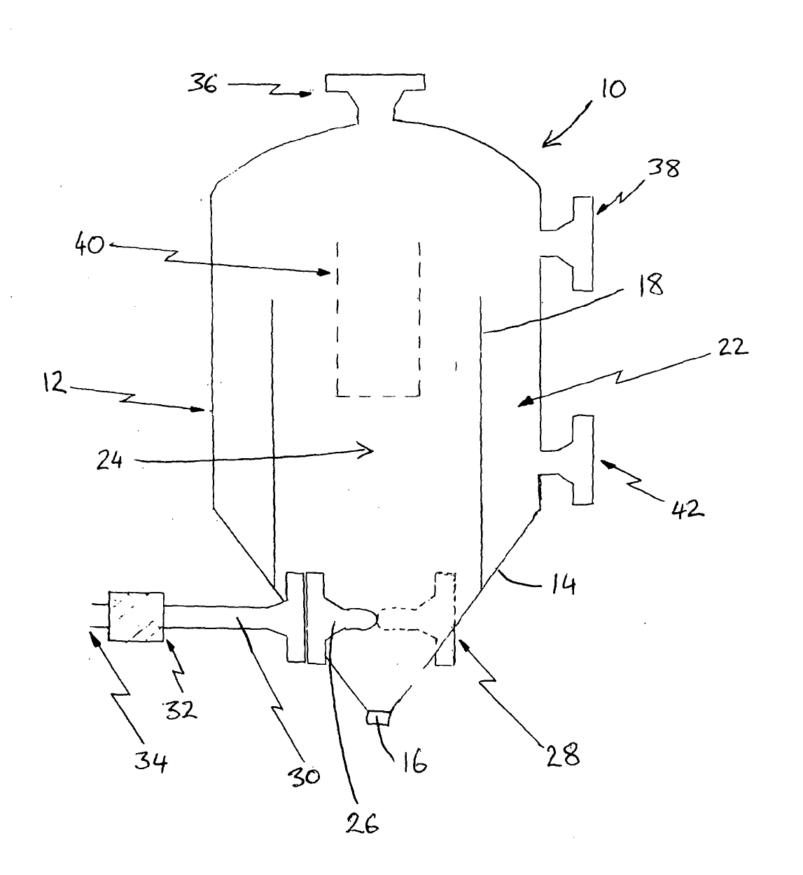

This invention concerns flotation apparatus, and particularly but not exclusively flotation apparatus for separating oil from water, and also a method of separating a mixture of oil and water.

It is well established to separate oil and water mixtures in oil field production installations, so that the water can subsequently be safely discharged. Such mixtures include dispersed or emulsified oil typically from crude oil production separators. The mixture may also include some solid material. One method commonly used for such separation is flotation, which may be carried out in compact flotation units (CFU's). Such a separation method may be used in conjunction with other separation techniques.

Such apparatus generally includes a vessel into which the mixture is fed, usually with a gas stream whereby the gas bubbles facilitate flotation of the lighter oil particles to an upper part of the vessel, with the heavier water fraction sinking to a lower part of the vessel. The mixture may be tangentially fed into the vessel to cause swirling of the mixture.

According to a first aspect of the invention there is provided separation apparatus for separating a mixture of oil and water, the apparatus comprising a separation vessel, a divider separating the vessel into a central zone and an outer annular zone surrounding the central zone, an upper part of the divider providing a weir to enable fluid in the central zone to pass over the divider into the outer zone, the apparatus also including an inlet to enable mixture to enter the vessel, the inlet being located at a lower part of the vessel and connecting into the central zone, an outlet for oil and/or gas being provided at an upper part of the vessel, and an outlet for water being provided at a lower part of the outer zone.

The outer zone may extend for only part way downwards towards the lower end of the vessel.

The lower end of the vessel may be conical or frusto conical and pointing downwardly. An outlet for solids may be provided at the lower end of the vessel. The lower end of the vessel may be provided by the central zone.

The inlet may be configured to cause mixture entering the vessel to swirl. The inlet may provide a tangential flow into the vessel.

A pair of inlets may be provided, and the inlets may be substantially diametrically opposite each other and may each provide a tangential flow into the vessel.

A swirl device may be provided at or adjacent the inlet to cause a mixture entering the vessel to swirl, and the swirl device may include a set of curved vanes.

The apparatus may include a gas injection arrangement for injecting gas into the mixture upstream of the inlet.

The apparatus may include a mixing arrangement for mixing the gas and mixture upstream of the inlet, and the mixing arrangement may comprise a restriction or shearing device.

The vessel may be substantially cylindrical.

The divider may comprise a substantially cylindrical part for separating the outer and central zones.

The outlet for oil and/or gas may be provided in an upper wall of the vessel.

Where oil and gas are also to be separated from each other, a further outlet may be provided for discharge of oil, and an oil removal compartment may be provided in an upper part of the vessel into which oil can weir or can be skimmed into, with the further outlet leading from the oil removing compartment.

According to a second aspect of the invention there is provided a method of separating oil and water, the method comprising using apparatus according to any of the preceding twelve paragraphs.

The gas may be injected with water into the mixture, and the water may be recycled from water exiting the apparatus.

An embodiment of the present invention will now be described by way of example only and with reference to the single FIGURE of the accompanying drawings, which is a diagrammatic cross sectional view of apparatus according to the invention.

The drawing shows apparatus 10 for separating an oil and water mixture, as typically could be produced in oil field production. The apparatus comprises a generally cylindrical vessel 12 with a conical lower part 14 leading to an outlet 16.

A cylindrical divider 18 is provided which extends from part way up the conical lower part 14 and divides the vessel into an annular outer zone 22 and a central zone 24, which central zone 24 extends to the lower part of the vessel 12.

A tangential inlet 26 extends into the conical lower part 14 a short distance above the outlet 16. A second diametrically opposite tangential inlet 28 as shown in dotted lines may also be provided. The tangential arrangement of the inlets 26, 28 is intended to introduce a swirl into liquid entering the vessel 12. In place or in addition to the tangential arrangement of the inlet or inlets 26, 28, a swirl device (not shown) may be provided which may comprise a set of curved vanes.

An inlet pipe 30 extends from the inlet 26 to a mixing device 32. An inlet 34 to the mixing device is connected to a supply of oil/water mixture and also a gas supply to cause flotation. The mixing device 32 inputs energy to the gas and oil/water mixture, and ensures a homogeneous mixing thereof.

An outlet 36 is provided at the upper end of the vessel 12 for oil and/or gas. A further outlet 38 may be provided on a side of the vessel above the top of the divider 18. The further outlet 38 may be connected to an oil removal compartment 40, shown in dotted lines in the drawing. A water outlet 42 is provided in the side of the vessel 12 a small distance above the bottom of the annular outer zone 22.

In use, an oil and water mixture and gas are fed through the inlet 34 to be mixed in the mixing device 32. This liquid and gas mixture then passes through the inlet pipe 30 and is injected through at least the inlet 26 into the vessel 12 so as to swirl therein. The mixture will rise within the central zone 24 to weir over the top of the cylindrical divider 18.

The gas will tend to carry the oil and any hydrocarbon gas upwardly, whilst water will weir over the divider and drop down in the annular outer zone 22. In the outer zone 22 any remaining gas should pass upwards, whilst cleaned water will pass to the water outlet 42 and can be taken out of the apparatus.

Any solids in the mixture will tend to drop to the bottom of the vessel 12, where due to the conical shape they will concentrate, and can readily be removed through the outlet 16.

The area above the divider 18 in the central zone serves as a settling volume with little upward or downward direction of flow, in which the light phase liquid droplets and gas bubbles can migrate upwardly for removal. This removal may be through the outlet 36. Removal could though be through the further outlet 38. Where hydrocarbon gas and oil are to be separated, the gas may be taken out through the outlet 36, whilst oil may weir over or be skimmed into the oil removal compartment 40 and be taken out through the further outlet 38.

Apparatus according to the invention has been found to have advantageous features and improved performance relative to prior arrangements. The swirl imparts a low centrifugal force to the liquid to encourage the migration of oil droplets and gas bubble/oil droplet agglomerations to the centre of the apparatus where they can coalesce more rapidly. The swirl also increases the probability of bubble/droplet encounters as the droplets cross the flow path of the upward rising bubbles.

Previous arrangements have provided introduction of liquid generally middway up a vessel to provide sufficient volume separation of the two liquid phases. This causes the gas to perform the flotation operation in a counter current direction to the movement of the liquid. The downward motion of liquid through the vessel reduces the effectiveness and only allows a portion of the full residence time of the liquid to be used as useful separation time.

Such prior arrangements do not allow for the disengagement of the injected gas, which can be entrained as fine bubbles in the discharge liquid. This can be detrimental to the operation of downstream centrifugal pumps where the rapid expansion of gas at the pump suction and subsequent bubble collapse of the high pressure pump discharge, can lead to damage to the pump impeller caused by flashing and cavitation.

In contrast, in the present invention liquid is introduced towards the base of the vessel enabling it to flow upward in a concurrent direction with the flotation gas, thereby removing the hindrances outlined above provided by the counter current flow. As liquid passes over the weir, the direction of the fluid is reversed to a downward direction at a low velocity providing for further disengagement of entrained gas. Furthermore in the present invention, there is a quiescent zone above the weir where very little vertical velocity exists and where residual gas bubbles can assist relatively unhindered in completing the droplet flotation process to the surface of the mixture.

Various modifications may be made without departing from the scope of the invention. As indicated above oil and hydrocarbon gas can be separated from each other. The swirl in the mixture can be produced with one or two tangential flows and/or by using a swirl device.

It may be that the flotation gas will be introduced to the mixture, as a gas and liquid mixture. For instance the gas could be premixed with water, which water could be recycled from the apparatus. A mixing device may not always be required for the oil/water mixture and gas supply.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Separation apparatus for separating a mixture of oil and water, the apparatus comprising a separation vessel, a divider separating the vessel into a central zone and an outer annular zone surrounding the central zone, an upper part of the divider providing a weir to enable fluid in the central zone to pass over the divider into the outer zone, the apparatus also including an inlet to enable a mixture of oil and water to enter the vessel, the inlet being located at a lower part of the vessel and connecting into the central zone, an outlet for oil and/or gas being provided at an upper part of the vessel, and an outlet for water being provided at a lower part of the outer zone, the outer zone extending for only part way downwards towards the lower end of the vessel, with the inlet being located below the outer zone.

2. (canceled)

3. Apparatus according to claim 1, characterised in that the lower end of the vessel is conical or frustoconical and pointing downwardly.

4. Apparatus according to claim 1, characterised in that an outlet for solids is provided at the lower end of the vessel.

5. Apparatus according to claim 1 characterised in that the lower end of the vessel is provided by the central zone.

6. Apparatus according to claim 1, characterised in that the inlet is configured to cause said mixture to swirl on entering the vessel.

7. Apparatus according to claim 6, characterised in that a swirl device is provided at or adjacent the inlet to cause said mixture to swirl on entering the vessel.

8. Apparatus according to claim 7, characterised in that the swirl device includes a set of curved vanes.

9. Apparatus according to claim 1, characterised in that the inlet provides a tangential flow into the vessel.

10. Apparatus according to claim 1, characterised in that a pair of inlets are provided.

11. Apparatus according to claim 10, characterised in that the inlets are substantially diametrically opposite each other, the inlets each providing a tangential flow into the vessel.

12. (canceled)

13. Apparatus according to claim 1, characterised in that the apparatus includes a gas injection arrangement for injecting gas into the mixture upstream of the inlet.

14. Apparatus according to claim 1, characterised in that the apparatus includes a mixing arrangement for mixing a gas and the mixture upstream of the inlet.

15. Apparatus according to claim 14, characterised in that the mixing arrangement comprises a restriction or shearing device.

16. Apparatus according to claim 1, characterised in that the vessel is substantially cylindrical.

17. Apparatus according to claim 1, characterised in that the divider comprises a substantially cylindrical part for separating the outer and central zones.

18. Apparatus according to claim 1, characterised in that the outlet for oil and/or gas is provided in an upper wall of the vessel.

19. Apparatus according to claim 1, characterised in that a further outlet is provided for discharge of oil to facilitate separation of oil and gas from one another.

20. Apparatus according to claim 19, characterised in that an oil removal compartment is provided in an upper part of the vessel into which oil can weir or can be skimmed, with the further outlet leading from the oil removing compartment.

21. A method of separating oil and water, comprising feeding a mixture of oil and water to the central zone of said apparatus according to claim 1 via said inlet, wherein the mixture rises through said central zone such that water from said mixture passes over an upper edge of said divider into said outer annular zone and oil continues rising through said vessel beyond said upper edge of said divider, delivering a separated water stream from said vessel and separately delivering a separated oil stream from said vessel.

22. A method according to claim 21, characterised in that a gas is injected with additional water into the mixture.

23. A method according to claim 22, characterised in that the additional water is recycled from said separated water stream exiting the vessel.

24-26. (canceled)
